(19) United States
(12) Patent Application Publication
(10) Pub. No.: US 2024/0397012 A1
(43) Pub. Date: Nov. 28, 2024

(54) IMAGE PROCESSING APPARATUS AND IMAGE PROCESSING METHOD

(71) Applicant: CANON KABUSHIKI KAISHA, Tokyo (JP)

(72) Inventor: MASATO FUKUDA, Tokyo (JP)

(21) Appl. No.: 18/670,504

(22) Filed: May 21, 2024

(30) Foreign Application Priority Data
May 24, 2023 (JP) 2023-085182

(51) Int. Cl. H04N 1/38; H04N 1/00

(52) U.S. Cl. CPC H04N 1/38; H04N 1/00803; H04N 1/00811

(57) ABSTRACT

An image processing apparatus receives scan settings made by an application installed on an information processing apparatus and compatible with image processing apparatuses of a plurality of vendors in common from the information processing apparatus, scans an image of a document based on the received scan settings to generate image data, executes a removal process on the generated image data based on a setting of removal included in the received scan settings, and transmits image data that is not removed by the removal process in the generated image data to the information processing apparatus. The image processing apparatus executes the removal process based on the setting of the removal included in the received scan settings and a level of the removal set regardless of execution of the application.

### BACKGROUND

### Technical Field

The aspect of the embodiments relates to an image processing apparatus and an image processing method.

### Description of the Related Art

There is known a technique that provides a unit with which a user changes a threshold for making a blank sheet determination through an operation unit of an image processing apparatus and makes the blank sheet determination on a scanned document using the set threshold (Japanese Patent Application Laid-Open No. 2001-143050).

It is conceivable that an app installed on an information processing apparatus and common to a plurality of vendors of image processing apparatuses receives scan settings and an instruction to execute scanning, and an image processing apparatus executes scanning. At this time, there is a case where the app cannot set setting values used when the image processing apparatus executes the scanning, which are the setting values of the detailed settings of a blank sheet determination as in Japanese Patent Application Laid-Open No. 2001-143050.

### SUMMARY

According to an aspect of the embodiments, an image processing apparatus includes a reception unit configured to receive scan settings made by an application installed on an information processing apparatus and compatible with image processing apparatuses of a plurality of vendors in common from the information processing apparatus, a scan unit configured to scan an image of a document based on the received scan settings and to generate image data, an execution unit configured to execute a removal process on the generated image data based on a setting of removal included in the received scan settings, and a transmission unit configured to transmit image data that is not removed by the removal process in the generated image data to the information processing apparatus. The execution unit executes the removal process based on the setting of the removal included in the received scan settings and a level of the removal set regardless of execution of the application.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a system.

FIG. 2 is a block diagram illustrating a general configuration of an image processing apparatus.

FIG. 3 is a diagram illustrating an example of a hardware configuration of an information processing apparatus.

FIG. 4 is a block diagram illustrating a functional configuration of a device control program for the image processing apparatus.

FIG. 5 is a sequence diagram illustrating an example of a blank sheet removal scanning process.

FIG. 6 is a diagram illustrating examples of screens of a scan app.

FIG. 7 is a flowchart illustrating an example of a scan job execution process.

FIG. 8 is a flowchart illustrating an example of a first blank sheet removal setting process.

FIGS. 9A to 9D are diagrams illustrating examples of a scan ticket.

FIG. 10 is a diagram illustrating an example of a default settings screen.

FIG. 11 is a flowchart illustrating an example of a second blank sheet removal setting process.

FIG. 12 is a flowchart illustrating an example of a first blank sheet removal level determination process.

FIG. 13 is a flowchart illustrating an example of a second blank sheet removal level determination process.

### DESCRIPTION OF THE EMBODIMENTS

Exemplary embodiments of the disclosure will be described in detail with reference to the attached drawings. The following exemplary embodiments do not limit the disclosure according to the appended claims, and not all the combinations of the features described in the exemplary embodiments are used in a method for solving the issues in the disclosure.

### Overall Configuration

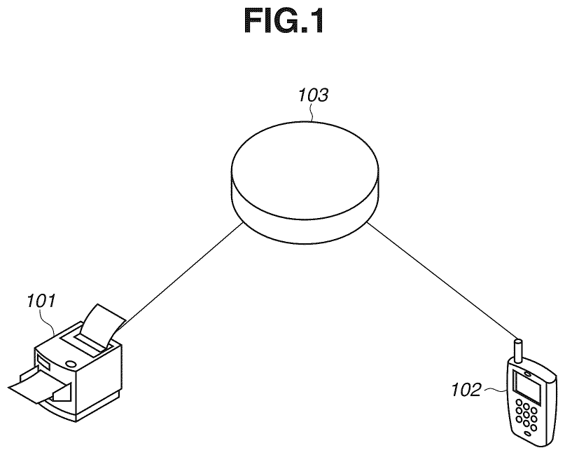

FIG. 1 is a diagram illustrating an example of the configuration of a system according to an exemplary embodiment. As illustrated in FIG. 1, for example, the system according to the present exemplary embodiment includes an image processing apparatus 101, an information processing apparatus 102, and a network 103. The system can include a plurality of information processing apparatuses.

The image processing apparatus 101 and the information processing apparatus 102 can communicate with each other via the network 103. In some embodiments, a configuration is employed in which the image processing apparatus 101 and the information processing apparatus 102 is connected not via a single connection but via a plurality of connections to each other.

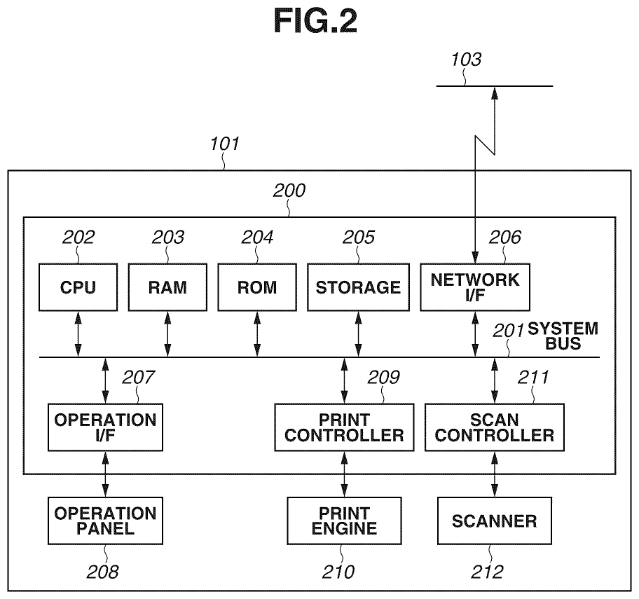

The image processing apparatus 101 is a multifunction peripheral with a plurality of functions, such as a copy function, a scan function, a print function, and a fax function. In other embodiments, the image processing apparatus 101 is an apparatus with a single function, such as a printer or a scanner. An operation panel 208 will be described below with reference to FIG. 2.

In other embodiments, the information processing apparatus 102 is a mobile terminal, such as a smartphone or a personal computer (PC), used by a user. The information processing apparatus 102 includes a unit for generating a scan job for generating image data on a document of a paper medium by the image processing apparatus 101 scanning the document, and a display unit for referring to the image data on a display unit 308.

### Hardware Configuration of Image Processing Apparatus

FIG. 2 is a block diagram illustrating the general configuration of the image processing apparatus 101 according to the present exemplary embodiment of the disclosure.

As illustrated in FIG. 2, the image processing apparatus 101 includes a central processing unit (CPU) 202, a random-access memory (RAM) 203, a read-only memory (ROM) 204, storage 205, a network interface (I/F) 206, an operation I/F 207, a print controller 209, and a scan controller 211, all of which are connected to a system bus 201.

The CPU 202 controls the general operation of the image processing apparatus 101. The CPU 202 reads a device control program 400 stored in the ROM 204 or the storage 205 and performs various types of control, such as reading control and print control.

The RAM 203 is a main storage memory of the CPU 202 and is used as a work area or a temporary storage area into which various control programs stored in the ROM 204 and the storage 205 are loaded.

The ROM 204 stores the device control program 400 as a control program that can be executed by the CPU 202.

The storage 205 stores print data, image data, various programs, and various pieces of setting information.

Although in the image processing apparatus 101 according to the present exemplary embodiment, a single CPU 202 executes processes illustrated in flowcharts described below, using a single memory (the RAM 203), another form may be employed. For example, a plurality of CPUs, RAMs, ROMs, and spaces of storage can also cooperate to execute the processes illustrated in the flowcharts described below. In other embodiments, some of the processes are executed using a hardware circuit, such as an application-specific integrated circuit (ASIC) or a field-programmable gate array (FPGA).

The network I/F 206 is an interface for causing the image processing apparatus 101 to communicate with an external device via the network 103. The image processing apparatus 101 transmits electronic data read by a scanner 212 to the information processing apparatus 102 via the network I/F 206. The image processing apparatus 101 also receives electronic data managed by the information processing apparatus 102 via the network I/F 206 and prints the electronic data using a print engine 210.

An operation panel 208 displays a screen controlled by the operation I/F 207. If the user operates the operation panel 208, the image processing apparatus 101 acquires an event corresponding to the operation of the user via the operation I/F 207.

The print controller 209 is connected to the print engine 210. Image data to be printed is transferred to the print engine 210 via the print controller 209.

The print engine 210 receives a control command and image data to be printed and forms an image based on the image data on a sheet. The printing method for the print engine 210 can be an electrophotographic method or an inkjet method. In the electrophotographic method, the print engine 210 forms an electrostatic latent image on a photosensitive member, then develops the electrostatic latent image with toner, transfers the toner image to a sheet, and fixes the transferred toner image, forming an image. On the other hand, in the inkjet method, the print engine 210 discharges ink, forming an image on a sheet.

The scan controller 211 is connected to the scanner 212. The scanner 212 reads an image on a sheet, generating image data. The image data generated by the scanner 212 is stored in the storage 205. The image processing apparatus 101 can also form an image on a sheet using the image data generated by the scanner 212. The scanner 212 includes a document feeder (not illustrated) and can read sheets placed in the document feeder while conveying the sheets one by one.

### Hardware Configuration of Information Processing Apparatus

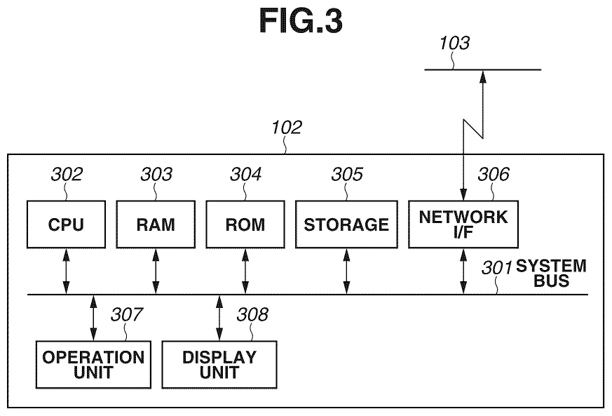

FIG. 3 is a diagram illustrating an example of the hardware configuration of the information processing apparatus 102 according to the present exemplary embodiment of the disclosure.

As illustrated in FIG. 3, the information processing apparatus 102 includes a CPU 302, a RAM 303, a ROM 304, storage 305, a network I/F 306, an operation unit 307, and a display unit 308, all of which are connected to a system bus 301.

The CPU 302 is a central processing unit that controls the general operation of the information processing apparatus 102. The RAM 303 is a volatile memory. The ROM 304 is a non-volatile memory and stores a start-up program for the CPU 302. The storage 305 is a storage device (e.g., a hard disk drive (HDD)) with a larger capacity than that of the RAM 303. In some embodiments, the storage 305 is a solid-state drive (SSD), or is replaced with another storage device with a function equivalent to that of a hard disk drive.

When the information processing apparatus 102 starts, such as when the information processing apparatus 102 is turned on, the CPU 302 executes the start-up program stored in the ROM 304. This start-up program is used to read a control program stored in the storage 305 and load the control program into the RAM 303. If the CPU 302 executes the start-up program, next, the CPU 302 executes the control program loaded into the RAM 303 and performs control. The CPU 302 also stores data used when the control program is executed in the RAM 303, and the CPU 302 reads and writes the data. The storage 305 can further store various settings when the control program is executed, and the CPU 302 reads and writes the various settings. The CPU 302 communicates with another device on the network 103 via the network I/F 306. The information processing apparatus 102 can also receive the contents of an operation, an input, and an instruction performed by the user using the operation unit 307.

On the storage 305 of the information processing apparatus 102, a scan application compatible with image processing apparatuses of a plurality of vendors in common is installed.

### Functional Configuration of Device Control Program for Image Processing Apparatus

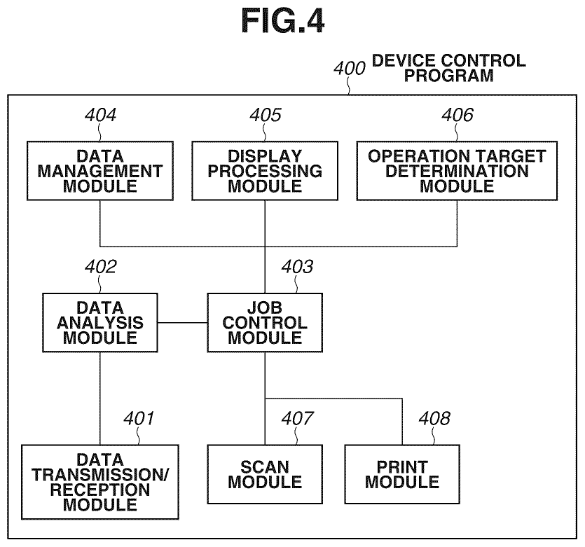

FIG. 4 is a block diagram illustrating the functional configuration of the device control program 400 for the image processing apparatus 101 executed by the CPU 202.

The device control program 400 for the image processing apparatus 101 is stored in the ROM 204 as described above and is loaded into the RAM 203 and executed by the CPU 202 when the image processing apparatus 101 starts.

A data transmission/reception module 401 transmits and receives data to and from another device on the network 103 using the Transmission Control Protocol/Internet Protocol (TCP/IP) via the network I/F 206. In the present exemplary embodiment, the data transmission/reception module 401 performs communication using the Hypertext Transfer Protocol (HTTP). Specifically, the data transmission/reception module 401 receives a scan ticket or an image data request generated by the information processing apparatus 102, and transmits the result of the generation of a job or responds to an image data request to the information processing apparatus 102 using HTTP.

A data analysis module 402 converts a job control command included in the body of an HTTP packet received by the data transmission/reception module 401 into job information for controlling a job of the image processing apparatus 101 and transmits the job information to a job control module 403. Examples of the job control command include eSCL, which is a protocol for controlling a scan job. eSCL is a protocol for executing scanning without using a driver by an information processing apparatus. Such a job control command is generated by the scan application installed on the information processing apparatus 102 and is received by the image processing apparatus 101.

The job control module 403 gives instructions to control the print engine 210 and the scanner 212 via the print controller 209 and the scan controller 211, respectively. For example, if a display processing module 405 detects the press of a start key while a send function screen is displayed, the job control module 403 receives parameters of a send job and an instruction to start a job from an operation target determination module 406. Then, the job control module 403 executes scanning based on job information regarding the job and performs control to transmit image data scanned by the scanner 212 to a destination set based on a parameter, such as an email address or the directory path of a shared server on the network 103. If the data transmission/reception module 401 receives an HTTP packet whose body including a job control command (a scan ticket) based on the eSCL protocol, the job control module 403 executes scanning based on job information obtained by the data analysis module 402 converting the job control command.

The job control command also includes a setting value that can be set on a settings screen 601, such as the resolution of scanning, and such a setting value is also transmitted from the information processing apparatus 102 to the image processing apparatus 101 based on the eSCL protocol and received by the image processing apparatus 101.

Then, the job control module 403 transmits image data read by the scanner 212 to the transmission source of the HTTP packet. A scan instruction analyzed by the data analysis module 402 can be given based on a protocol other than the eSCL protocol as long as the protocol is common to a plurality of vendors or models of multifunction peripherals.

A data management module 404 saves and manages a variety of pieces of data, such as work data generated in the execution of the device control program 400 and setting parameters used to control devices, in predetermined areas in the RAM 203 and the storage 205. For example, the data management module 404 saves and manages job information including the combination of the setting items and the setting values of a job to be executed by the job control module 403 and a language setting as information regarding a language displayed on the operation panel 208. The data management module 404 also saves and manages device information used to communicate with the information processing apparatus 102. The data management module 404 also saves and manages image data on an image to be formed by the image processing apparatus 101. The data management module 404 also saves screen control information used for screen display control by the display processing module 405 and operation target determination information used to determine an operation target by the operation target determination module 406, and manages the screen control information and the operation target determination information with respect to each screen displayed by the display processing module 405.

The display processing module 405 controls the operation panel 208 via the operation I/F 207. More specifically, the display processing module 405 displays user interface (UI) components (a button, a pull-down list, and a checkbox) that can be operated by the user on the operation panel 208. A screen is updated based on screen display control information. For example, the display processing module 405 acquires a language dictionary corresponding to the language setting saved in the data management module 404 from the storage 205 and displays text data based on the language dictionary on the screen.

The operation target determination module 406 acquires the coordinates of a point touched on the operation panel 208 via the operation I/F 207 and determines a UI component that is displayed on the operation panel 208 and can be operated by the user as an operation target.

Further, the operation target determination module 406 reads screen display control information corresponding to the UI component determined as the operation target, and based on the information, determines processing when an operation is received. For example, the operation target determination module 406 gives an instruction to update the display content of the screen to the display processing module 405 or transmits parameters of a job set by an operation of the user and an instruction to start the job to the job control module 403.

Based on scan job information from the job control module 403, a scan module 407 executes scanning using the scanner 212 via the scan controller 211 and saves read image data in the data management module 404.

Based on print job information from the job control module 403, a print module 408 executes printing using the print engine 210 via the print controller 209.

### Blank Sheet Removal Scanning Sequence

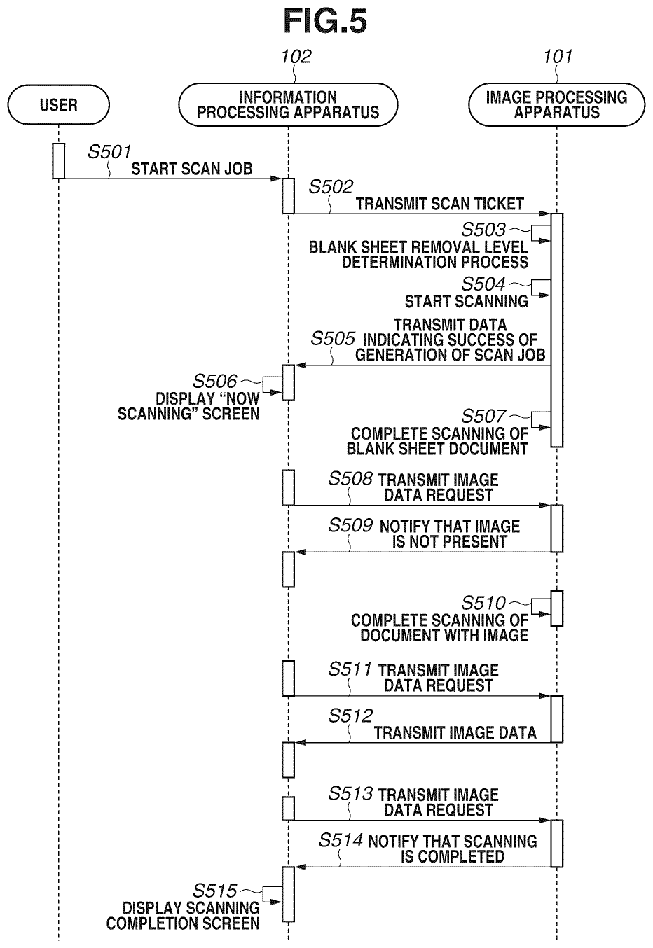

FIG. 5 is a sequence diagram illustrating an example of a blank sheet removal scanning process executed by the image processing apparatus 101 and the information processing apparatus 102 according to the present exemplary embodiment of the disclosure. In the present exemplary embodiment, the user places two document sheets in the document feeder of the image processing apparatus 101 in advance so that scanning is performed in the order of a “blank sheet document” and a “document with an image”. In the present exemplary embodiment, the information processing apparatus 102 and the image processing apparatus 101 communicate with each other using HTTP.

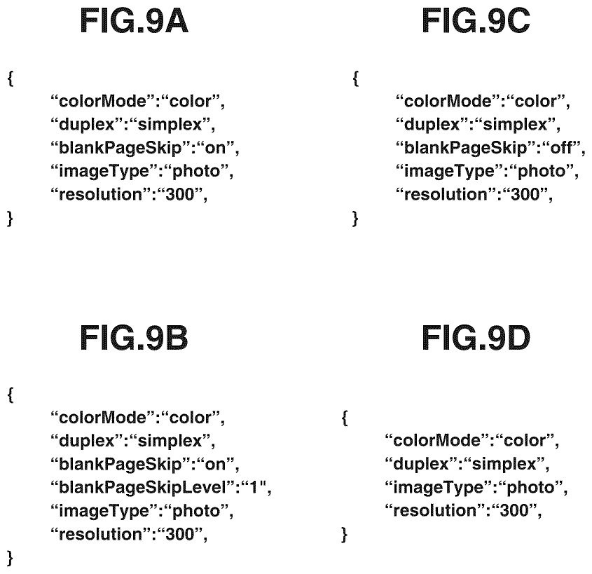

In step S501, the user makes scan job settings on the settings screen 601 displayed on the display unit 308 of the information processing apparatus 102 and then presses a “scan” button 607. In step S502, the CPU 302 of the information processing apparatus 102 generates a blank sheet removal scan ticket (FIG. 9A) based on the scan job settings made on the settings screen 601. Then, the CPU 302 of the information processing apparatus 102 transmits the blank sheet removal scan ticket (FIG. 9A) to the image processing apparatus 101 via the network I/F 306 using an HTTP POST request. What is generated and transmitted at this time can be a scan ticket, or can be a scan job, a scan request, or a scan instruction. FIG. 9A is a diagram illustrating an example of the scan ticket.

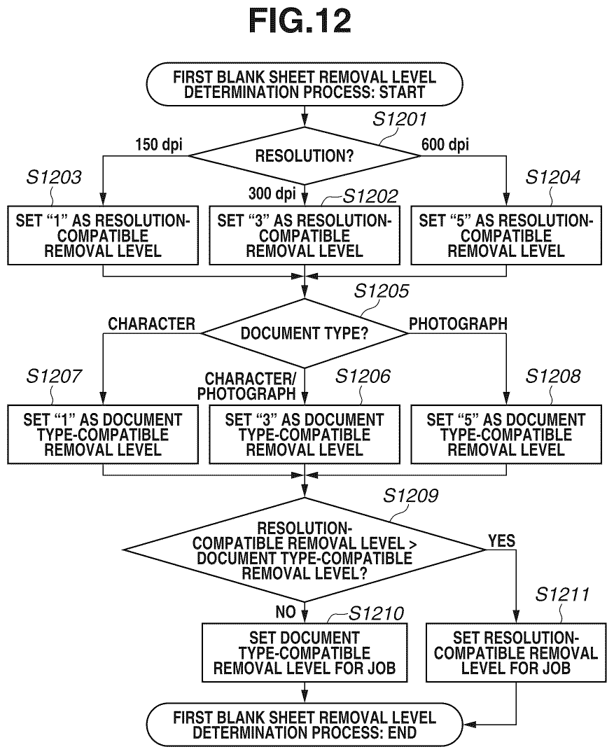

In step S503, the CPU 202 of the image processing apparatus 101 saves the blank sheet removal scan ticket (FIG. 9A) received in step S502 in the RAM 203, executes a first blank sheet removal level determination process (FIG. 12), and determines a blank sheet removal level.

In step S504, the CPU 202 of the image processing apparatus 101 generates scan job information based on the scan ticket stored in the RAM 203 and the blank sheet removal level determined in step S503 and starts executing a scan job. The scan job is executed, whereby an image of a document is scanned, and image data is generated.

In step S505, the CPU 202 of the image processing apparatus 101 transmits HTTP response data with the HTTP response status code “200”, which is data to which a “job ID” as an identifier (ID) corresponding to the executed job is assigned, to the information processing apparatus 102.

In step S506, the CPU 302 of the information processing apparatus 102 displays a “now scanning” screen 609 on the display unit 308.

If the scanning of a blank sheet document is completed, then in step S507, based on the blank sheet removal level determined in step S503, the CPU 202 of the image processing apparatus 101 determines whether image data generated by scanning the blank sheet document is blank sheet data. If it is determined that the image data is blank sheet data, the CPU 202 of the image processing apparatus 101 deletes the image data of the blank sheet document saved in the RAM 203.

In step S508, the CPU 302 of the information processing apparatus 102 transmits an image data acquisition request command to which the “job ID” acquired in step S505 is assigned to the image processing apparatus 101 via the network I/F 306 using an HTTP GET request.

In step S509, the CPU 202 of the image processing apparatus 101 confirms that the job corresponding to the “job ID” of which the image processing apparatus 101 is notified in step S508 is currently being executed and image data is not present in the RAM 203. If the job is currently being executed and image data is not present in the image memory, the image processing apparatus 101 transmits HTTP response data with the HTTP response status code “503” to the information processing apparatus 102. That is, the image processing apparatus 101 notifies the information processing apparatus 102 that image data is not present.

If the scanning of a document with an image is completed, then in step S510, based on the blank sheet removal level determined in step S503, the CPU 202 of the image processing apparatus 101 determines that image data on the document with an image is not blank sheet data. In this case, the CPU 202 of the image processing apparatus 101 does not delete the image data on the “document with an image” from the RAM 203.

In step S511, the CPU 302 of the information processing apparatus 102 transmits an image data acquisition request command to which the “job ID” acquired in step S505 is assigned to the image processing apparatus 101 via the network I/F 306 using an HTTP GET request.

In step S512, the CPU 202 of the image processing apparatus 101 confirms that the job corresponding to the “job ID” of which the image processing apparatus 101 is notified in step S508 is currently being executed and image data is present in the image memory. If the job is currently being executed and image data is present in the RAM 203, the image processing apparatus 101 transmits HTTP response data with the HTTP response status code “200” and including the image data to the information processing apparatus 102.

In step S513, the CPU 302 of the information processing apparatus 102 transmits an image data acquisition request command to which the “job ID” acquired in step S505 is assigned to the image processing apparatus 101 via the network I/F 306 using an HTTP GET request.

In step S514, if the CPU 202 of the image processing apparatus 101 confirms that the job corresponding to the “job ID” of which the image processing apparatus 101 is notified in step S508 is not currently being executed, the CPU 202 of the image processing apparatus 101 executes the following process. The CPU 202 of the image processing apparatus 101 transmits HTTP response data that includes the HTTP response status code “404” and does not include image data to the information processing apparatus 102. That is, the image processing apparatus 101 notifies the information processing apparatus 102 that the execution of the job is completed.

In step S515, the CPU 302 of the information processing apparatus 102 displays a scanning completion screen 611 on the display unit 308.

If only a blank sheet document is placed in the document feeder, image data is not transmitted to the information processing apparatus 102. If the CPU 302 determines that image data is not present when the CPU 302 receives the HTTP response status “404”, the CPU 302 displays an error screen 613 on the display unit 308.

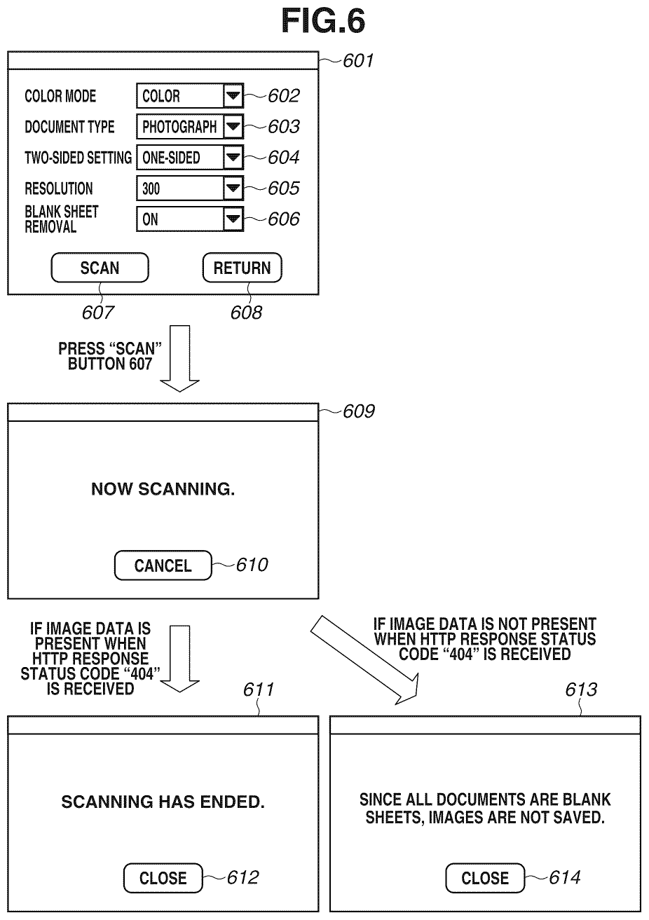

FIG. 6 is a diagram illustrating examples of screens of the scan app. Each screen in FIG. 6 is a screen displayed on the display unit 308 of the information processing apparatus 102 by the scan app installed on the information processing apparatus 102. The scan app is a scan app, used in common regardless of the vendor or the model of the image processing apparatus, for generating and transmitting a scan instruction, such as a command or a ticket for causing a variety of models to execute scanning. The use of the scan app eliminates the need to install a plurality of scan apps to cause a plurality of models to execute scanning.

A settings screen 601 is a screen for receiving scan settings made by the user. A pull-down list 602 allows the selection of the color mode, “color” or “monochrome”.

A pull-down list 603 allows the selection of the document type, “character”, “photograph”, or “character/photograph”. A pull-down list 604 allows the selection of the two-sided setting, that is, selection between two-sided scanning and one-sided scanning. A pull-down list 605 allows the selection of the resolution when scanning is performed. A pull-down list 606 allows the selection of a blank sheet removal setting, “on” or “off”.

A “scan” button 607 is a button for being selected, scanning an image of a document based on the setting values set in the pull-down lists 602 to 606 and generating image data. Specifically, if the “scan” button 607 is selected, a scan ticket is generated based on the setting values set in the pull-down lists 602 to 606, and the generated scan ticket is transmitted to the image processing apparatus 101 specified in advance. Instead of the scan ticket, another form can be employed as long as the set setting values are transmitted to the image processing apparatus 101. While an example has been described where all the setting values of the pull-down lists 602 to 606 are transmitted in the present exemplary embodiment, the disclosure is not limited to this. For example, the setting and the transmission of all the setting values are not essential, and can be omitted. For example, only the color mode and the blank sheet removal setting can be transmitted, or only the blank sheet removal setting can be transmitted. On the settings screen 601 in FIG. 6, the document size, the file format, or the file name can be set. If a “return” button 608 is selected, the settings are reset.

If the “scan” button 607 is selected and the image processing apparatus 101 is executing scanning, a “now scanning” screen 609 is displayed on the display unit 308. If a “cancel” button 610 is selected, a cancellation instruction is transmitted to the image processing apparatus 101, and the execution of the scanning is stopped.

If the information processing apparatus 102 receives the HTTP response status code “404” from the image processing apparatus 101 and image data is included in already received HTTP response data, the scanning completion screen 611 is displayed. That is, if image data is received during the period from when an instruction to execute scanning is given by selecting the “scan” button 607 to when a notification indicating the end of scanning is received from the image processing apparatus 101, the scanning completion screen 611 is displayed.

If a “close” button 612 on the scanning completion screen 611 is selected, the scanning completion screen 611 is closed, and the settings screen 601 is displayed.

If the information processing apparatus 102 receives the HTTP response status code “404” from the image processing apparatus 101 and image data is not included in already received HTTP response data, the error screen 613 is displayed. That is, if image data is not received during the period from when an instruction to execute scanning is given by selecting the “scan” button 607 to when a notification indicating the end of scanning is received from the image processing apparatus 101, the error screen 613 is displayed.

The error screen 613 displays information indicating that all documents are blank sheets as a result of the scanning. If a “close” button 614 is selected, the error screen 613 is closed, and the settings screen 601 is displayed.

In this scan app, a setting item regarding whether to perform blank sheet removal is prepared in the pull-down list 606. However, a setting item regarding at which level the blank sheet removal is to be performed when the blank sheet removal is performed is not prepared. Even if the scan app further gives an instruction to execute scanning, the setting value of the blank sheet removal level is not transmitted. On the other hand, to perform the blank sheet removal in the image processing apparatus 101, the blank sheet removal level is to have been determined in advance. Thus, a setting value that cannot be set by a standard app, such as the scan app, is to be complemented in the image processing apparatus 101.

### Scan Job Execution Process

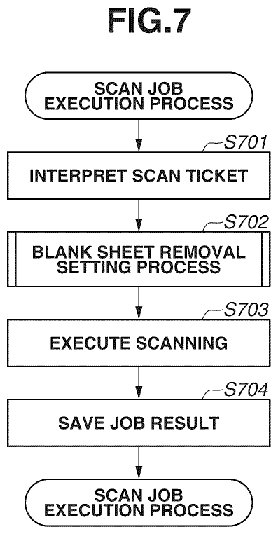

FIG. 7 is a flowchart illustrating an example of a scan job execution process executed by the CPU 202 of the image processing apparatus 101 according to the present exemplary embodiment. Processes in the flowchart in FIG. 7 are performed by the CPU 202 of the image processing apparatus 101 loading a program stored in the ROM 204 into the RAM 203 and executing the program.

In step S701, the CPU 202 of the image processing apparatus 101 generates scan job information including a job ID as an ID indicating a job based on a scan ticket saved in the RAM 203 and saves the scan job information in the RAM 203.

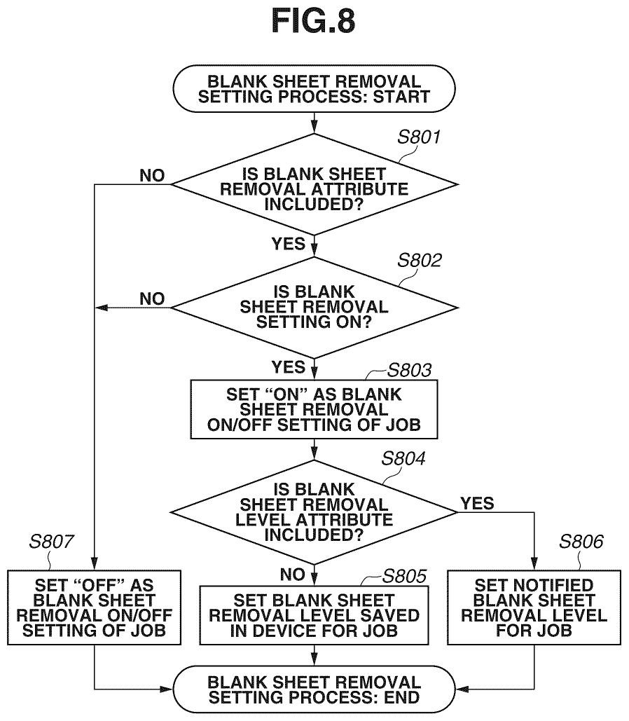

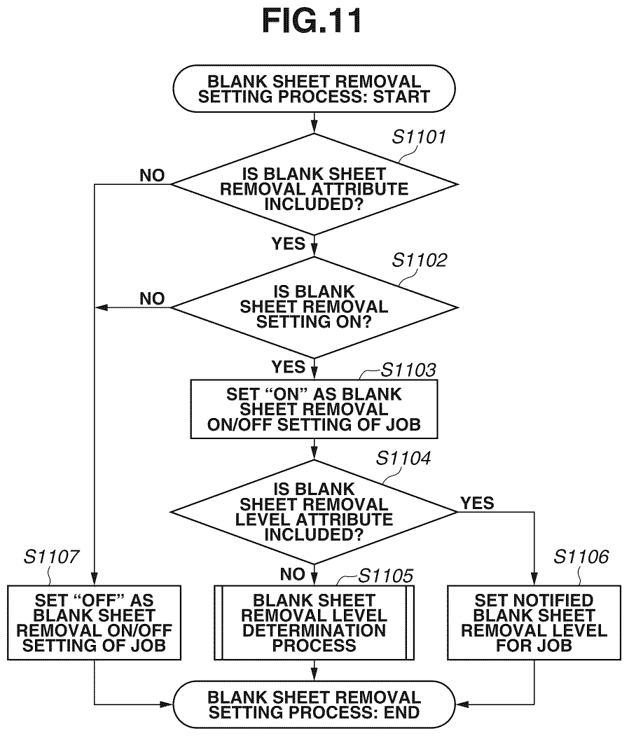

In step S702, the CPU 202 of the image processing apparatus 101 executes a blank sheet removal setting process. In the blank sheet removal setting process, the CPU 202 of the image processing apparatus 101 makes a “blank sheet removal on/off setting” indicating whether to enable or disable the blank sheet removal. Further, the CPU 202 of the image processing apparatus 101 performs the process of making settings related to the blank sheet removal, such as the “blank sheet removal level” for determining a threshold for determining whether a scanned document is a blank sheet based on luminance information regarding the scanned document, “colored paper”, “show-through”, “ruled line”, and “few characters”. Examples of the blank sheet removal setting process include a first blank sheet removal setting process (FIG. 8) and a second blank sheet removal setting process (FIG. 11).

In step S703, the CPU 202 of the image processing apparatus 101 causes the job control module 403 to execute a scan job based on the scan job information saved in the RAM 203. If the scan job is executed, the CPU 202 gives an instruction to start scanning corresponding to the scan job information to the scanner 212 via the scan controller 211. If scanning is started, the CPU 202 stores image data scanned by the scanner 212 in the RAM 203. Then, the CPU 202 executes a blank sheet removal process on the stored image data based on the setting values set in step S702. Image data determined to be a blank sheet is deleted from the RAM 203, and image data determined not to be a blank sheet remains stored in the RAM 203.

If the CPU 202 of the image processing apparatus 101 receives an image data request from the information processing apparatus 102, the CPU 202 of the image processing apparatus 101 confirms whether page information is present in the RAM 203. Then, the CPU 202 of the image processing apparatus 101 identifies the area of image data from the page information with the smallest page number. Then, the CPU 202 of the image processing apparatus 101 executes a transmission process for transmitting the image data to the information processing apparatus 102. If all image data for a single page is transmitted to the information processing apparatus 102, the CPU 202 of the image processing apparatus 101 deletes the image data corresponding to the page information corresponding to the transmitted page from the RAM 203. Generally, in continuous scanning using the document feeder, the CPU 202 of the image processing apparatus 101 executes a scanning process for a single page and an image data transmission process in parallel.

In step S704, if the scanning of all documents is completed, the CPU 202 of the image processing apparatus 101 saves a “job result” in which the job ID and the end factor of the job corresponding to the cause of the end of the job are associated with each other in the storage 205. Examples of the end factor of the job include a “normal end”, in which all image data is transmitted to the information processing apparatus 102, a “jam”, which is the end of the job due to a paper jam in the document feeder, and a “transmission error”, in which communication with the information processing apparatus 102 is disconnected in the middle of the transmission of image data.

### First Blank Sheet Removal Setting Process

FIG. 8 is a flowchart illustrating an example of the first blank sheet removal setting process executed by the CPU 202 of the image processing apparatus 101 according to the present exemplary embodiment. The processes in the flowchart in FIG. 8 are performed by the CPU 202 of the image processing apparatus 101 loading a program stored in the ROM 204 into the RAM 203 and executing the program. In the present exemplary embodiment, the scan ticket is character strings in the JavaScript Object Notation (JSON) format in which the blank sheet removal attribute is defined by “blankPageSkip” and the blank sheet removal level attribute is defined by “blankPageSkipLevel”.

In step S801, the CPU 202 of the image processing apparatus 101 determines whether the blank sheet removal attribute is included in the scan ticket saved in the RAM 203. The CPU 202 of the image processing apparatus 101 determines that the blank sheet removal attribute is included in a blank sheet removal scan ticket including “blankPageSkip” (FIG. 9A, 9B, or 9C). The CPU 202 of the image processing apparatus 101 determines that the blank sheet removal attribute is not included in a blank sheet removal scan ticket that does not include “blankPageSkip” (FIG. 9D).

If it is determined in step S801 that the blank sheet removal attribute is included in the scan ticket (Yes in step S801), then in step S802, the CPU 202 of the image processing apparatus 101 determines whether the blank sheet removal setting of the scan ticket saved in the RAM 203 is on. The CPU 202 of the image processing apparatus 101 determines that the blank sheet removal setting is on in a blank sheet removal scan ticket in which the value of “blankPageSkip” is “on” (FIG. 9A or 9B). The CPU 202 of the image processing apparatus 101 determines that the blank sheet removal setting is not on in a blank sheet removal scan ticket in which the value of “blankPageSkip” is “off” (FIG. 9C).

If it is determined in step S802 that the blank sheet removal setting is on (Yes in step S802), then in step S803, the CPU 202 of the image processing apparatus 101 sets “on” as the “blank sheet removal on/off setting” of the job attributes.

In step S804, the CPU 202 of the image processing apparatus 101 determines whether the blank sheet removal level attribute is included in the scan ticket saved in the RAM 203. The CPU 202 of the image processing apparatus 101 determines that the blank sheet removal level attribute is included in a blank sheet removal scan ticket including “blankPageSkipLevel” (FIG. 9B). The CPU 202 of the image processing apparatus 101 determines that the blank sheet removal level attribute is not included in a blank sheet removal scan ticket that does not include “blankPageSkipLevel” (FIG. 9A).

If it is determined in step S804 that the blank sheet removal level attribute is not included (No in step S804), then in step S805, the CPU 202 of the image processing apparatus 101 sets a removal level saved in the image processing apparatus 101 as the “blank sheet removal level” of the job information. The removal level saved in the image processing apparatus 101 is a setting value set regardless of the scan ticket received from the information processing apparatus 102 by the image processing apparatus 101. In other words, the removal level saved in the image processing apparatus 101 is the level of the blank sheet removal set regardless of the execution of the scan application installed on the information processing apparatus 102. The removal level saved in the image processing apparatus 101 is also a setting value set and stored in the image processing apparatus 101 before the image processing apparatus 101 receives the scan ticket from the information processing apparatus 102.

An example of the removal level saved in the image processing apparatus 101 cab be “3” saved as a “blank sheet removal level definition value” in the ROM 204, or a “blank sheet removal level default setting” saved in the storage 205. For example, the “blank sheet removal level default setting” is set on a default settings screen 1001 of the image processing apparatus 101. If the level is selected in a pull-down list 1008 and a “set” button 1010 is pressed on a default settings screen 1007 displayed after “on” is selected in a pull-down list 1004, the selected removal level is saved as a default setting in the storage 205.

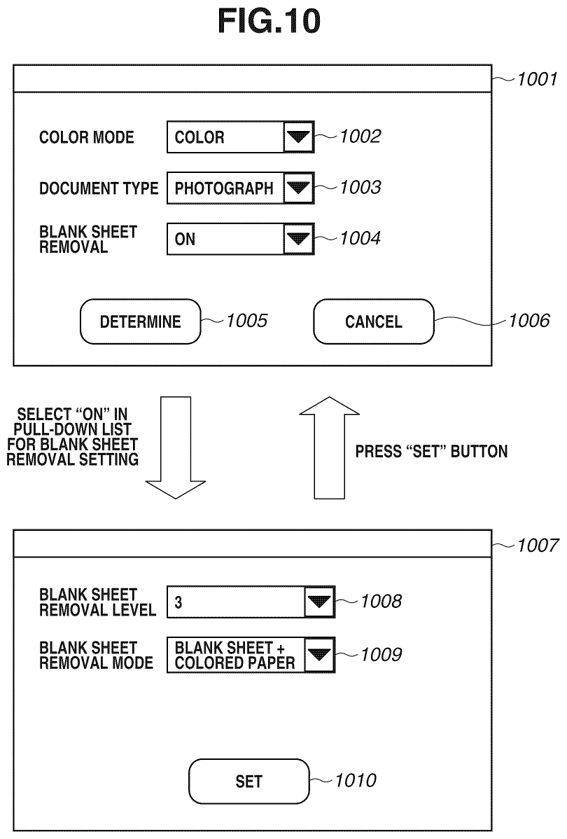

FIG. 10 is a diagram illustrating examples of default settings screens. Default settings screens 1001 and 1007 in FIG. 10 are screens displayed on the display unit 308 of the information processing apparatus 102 or the operation panel 208 of the image processing apparatus 101.

A pull-down list 1002 is a pull-down list for selecting the default setting of the color mode and allows the user to select “color” or “monochrome”.

A pull-down list 1003 is a pull-down list for selecting the default setting of the document type and allows the user to select “photograph”, “character”, or “character/photograph”.

A pull-down list 1004 is a pull-down list for setting the default setting of the blank sheet removal and allows the user to select “on” or “off”.

If a “determine” button 1005 is selected, the set setting values are stored in the storage 205. If a “cancel” button 1006 is selected, the setting values are reset.

If “on” is selected in the pull-down list 1004, the default settings screen 1007 is displayed. A pull-down list 1008 is a pull-down list for selecting the default setting of the blank sheet removal level and allows the user to select the level from “1” to “5”. A pull-down list 1009 is a pull-down list for selecting the default setting of a blank sheet removal mode and allows the user to select “blank sheet” or “blank sheet+colored paper”.

If a “set” button 1010 is selected, the setting values set in the pull-down lists 1008 and 1009 are stored in the RAM 203, and the settings screen 1001 is displayed.

The description returns to FIG. 8. If it is determined in step S804 that the blank sheet removal level attribute is included (Yes in step S804), then in step S806, the CPU 202 of the image processing apparatus 101 sets the value of “blankPageSkipLevel” as the “blank sheet removal level setting” of the job attributes.

If it is determined in step S801 that the blank sheet removal attribute is not included in the scan ticket data (No in step S801), or if it is determined in step S802 that the blank sheet removal setting is not on (No in step S802), then in step S807, the CPU 202 sets “off” as the “blank sheet removal on/off setting” of the job attributes.

### Second Blank Sheet Removal Setting Process

FIG. 11 is a flowchart illustrating an example of the second blank sheet removal setting process executed by the CPU 202 of the image processing apparatus 101 according to the present exemplary embodiment. Processes in the flowchart in FIG. 11 are performed by the CPU 202 of the image processing apparatus 101 loading a program stored in the ROM 204 into the RAM 203 and executing the program. In the present exemplary embodiment, the scan ticket is character strings in the JSON format in which a blank sheet removal attribute is defined by “blankPageSkip” and a blank sheet removal level attribute is defined by “blankPageSkipLevel”. In this procedure, another form of the first blank sheet removal setting process described with reference to FIG. 8 is described.

In step S1101, the CPU 202 of the image processing apparatus 101 determines whether the blank sheet removal attribute is included in the scan ticket saved in the RAM 203. The CPU 202 of the image processing apparatus 101 determines that the blank sheet removal attribute is included in a blank sheet removal scan ticket including “blankPageSkip” (FIG. 9A, 9B, or 9C). The CPU 202 of the image processing apparatus 101 determines that the blank sheet removal attribute is not included in a blank sheet removal scan ticket that does not include “blankPageSkip” (FIG. 9D).

If it is determined in step S1101 that the blank sheet removal attribute is included in the scan ticket (Yes in step S1101), then in step S1102, the CPU 202 of the image processing apparatus 101 determines whether the blank sheet removal setting of the scan ticket saved in the RAM 203 is on. The CPU 202 of the image processing apparatus 101 determines that the blank sheet removal setting is on in a blank sheet removal scan ticket in which the value of “blankPageSkip” is “on” (FIG. 9A or 9B). The CPU 202 of the image processing apparatus 101 determines that the blank sheet removal setting is not on in a blank sheet removal scan ticket in which the value of “blankPageSkip” is “off” (FIG. 9C).

If it is determined in step S1102 that the blank sheet removal setting is on (Yes in step S1102), then in step S1103, the CPU 202 of the image processing apparatus 101 sets “on” as the “blank sheet removal on/off setting” of the job attributes.

In step S1104, the CPU 202 of the image processing apparatus 101 determines whether the blank sheet removal level attribute is included in the scan ticket saved in the RAM 203. The CPU 202 of the image processing apparatus 101 determines that the blank sheet removal level attribute is included in a blank sheet removal scan ticket including “blankPageSkipLevel” (FIG. 9B). The CPU 202 of the image processing apparatus 101 determines that the blank sheet removal level attribute is not included in a blank sheet removal scan ticket that does not include “blankPageSkipLevel” (FIG. 9A).

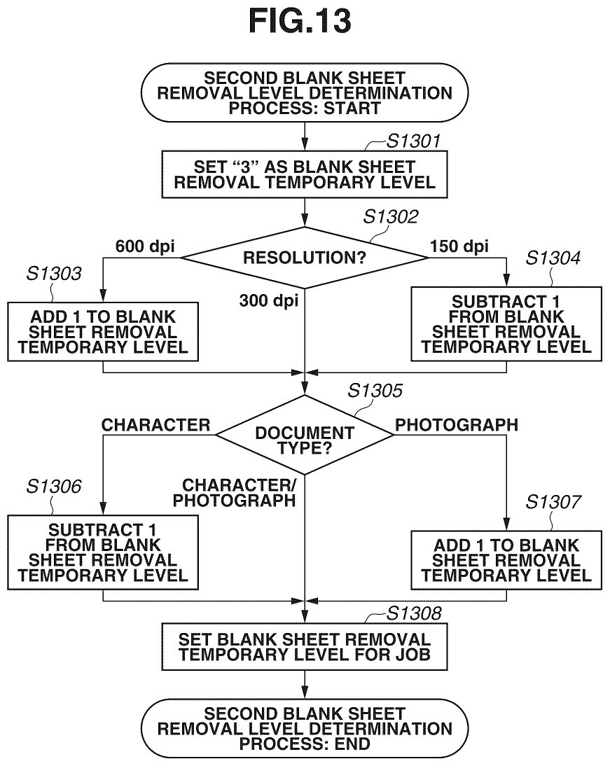

If it is determined in step S1104 that the blank sheet removal level attribute is not included (No in step S1104), then in step S1105, the CPU 202 of the image processing apparatus 101 executes a blank sheet removal level determination process. Examples of the blank sheet removal level determination process include a first blank sheet removal level determination process (FIG. 12) and a second blank sheet removal level determination process (FIG. 13).

If it is determined in step S1104 that the blank sheet removal level attribute is included (Yes in step S1104), then in step S1106, the CPU 202 of the image processing apparatus 101 sets the value of “blankPageSkipLevel” as the “blank sheet removal level setting” of the job attributes.

If it is determined in step S1101 that the blank sheet removal attribute is not included in the scan ticket (No in step S1101), or if it is determined in step S1102 that the blank sheet removal setting is not on (No in step S1102), then in step S1107, the CPU 202 sets “off” as the “blank sheet removal on/off setting” of the job attributes.

### First Blank Sheet Removal Level Determination Process

FIG. 12 is a flowchart illustrating an example of the first blank sheet removal level determination process executed by the CPU 202 of the image processing apparatus 101 according to the present exemplary embodiment. Processes in the flowchart in FIG. 12 are performed by the CPU 202 of the image processing apparatus 101 loading a program stored in the ROM 204 into the RAM 203 and executing the program. In the present exemplary embodiment, any of the values “150 dpi”, “300 dpi”, and “600 dpi” can be set as the “resolution”, and any of the values “character”, “photograph”, and “character/photograph” can be set as the “document type”.

In step S1201, the CPU 202 of the image processing apparatus 101 confirms which of the values “150 dpi”, “300 dpi”, and “600 dpi” is set as the resolution of the job attributes saved in the RAM 203. In the following process, the level of the blank sheet removal can be identified and set based on the setting of the resolution included in the scan settings received from the information processing apparatus 102.

If it is determined in step S1201 that the resolution of the job attributes is “300 dpi” (“300 dpi” in step S1201), then in step S1202, the CPU 202 of the image processing apparatus 101 sets “3” as a “resolution-compatible removal level” in the RAM 203.

If it is determined in step S1201 that the resolution of the job attributes is “150 dpi” (“150 dpi” in step S1201), then in step S1203, the CPU 202 of the image processing apparatus 101 sets “1” as the “resolution-compatible removal level” in the RAM 203.

If it is determined in step S1201 that the resolution of the job attributes is “600 dpi” (“600 dpi” in step S1201), then in step S1204, the CPU 202 of the image processing apparatus 101 sets “5” as the “resolution-compatible removal level” in the RAM 203.

In the following process, the level of the blank sheet removal can also be identified and set based on the setting of the document type included in the scan settings received from the information processing apparatus 102.

In step S1205, the CPU 202 of the image processing apparatus 101 confirms which of the values “character”, “photograph”, and “character/photograph” is set as the document type of the job attributes saved in the RAM 203.

If it is determined in step S1205 that the document type of the job attributes is “character/photograph” (“character/photograph” in step S1205), then in step S1206, the CPU 202 of the image processing apparatus 101 sets “3” as a “document type-compatible removal level” in the RAM 203.

If it is determined in step S1205 that the document type of the job attributes is “character” (“character” in step S1205), then in step S1207, the CPU 202 of the image processing apparatus 101 sets “1” as the “document type-compatible removal level” in the RAM 203.

If it is determined in step S1205 that the document type of the job attributes is “photograph” (“photograph” in step S1205), then in step S1208, the CPU 202 of the image processing apparatus 101 sets “5” as the “document type-compatible removal level” in the RAM 203.

In step S1209, the CPU 202 of the image processing apparatus 101 determines whether the value of the “resolution-compatible removal level” in the RAM 203 is greater than the value of the “document type-compatible removal level” in the RAM 203.

If it is determined in step S1209 that the value of the “resolution-compatible removal level” is not greater than the value of the “document type-compatible removal level” (No in step S1209), then in step S1210, the CPU 202 of the image processing apparatus 101 sets the value of the “document type-compatible removal level” as the blank sheet removal level of the job attributes.

If it is determined in step S1209 that the value of the “resolution-compatible removal level” is greater than the value of the “document type-compatible removal level” (Yes in step S1209), then in step S1211, the CPU 202 of the image processing apparatus 101 sets the value of the “resolution-compatible removal level” as the blank sheet removal level of the job attributes.

### Second Blank Sheet Removal Level Determination Process

FIG. 13 is a flowchart illustrating an example of the second blank sheet removal level determination process executed by the CPU 202 of the image processing apparatus 101 according to the present exemplary embodiment. Processes in the flowchart in FIG. 13 are performed by the CPU 202 of the image processing apparatus 101 loading a program stored in the ROM 204 into the RAM 203 and executing the program. In the present exemplary embodiment, any of the values “150 dpi”, “300 dpi”, and “600 dpi” can be set as the “resolution”, and any of the values “character”, “photograph”, and “character/photograph” can be set as the “document type”. The procedure in FIG. 13 illustrates an example of processing in another form of the first blank sheet removal level determination process in FIG. 12.

In step S1301, the CPU 202 of the image processing apparatus 101 sets “3” as a “blank sheet removal temporary level” in the RAM 203.

In step S1302, the CPU 202 of the image processing apparatus 101 confirms which of the values “150 dpi”, “300 dpi”, and “600 dpi” is set as the resolution of the job attributes saved in the RAM 203.

If it is determined in step S1302 that the resolution of the job attributes is “600 dpi” (“600 dpi” in step S1302), then in step S1303, the CPU 202 of the image processing apparatus 101 sets a value obtained by adding 1 to the “blank sheet removal temporary level” as the “blank sheet removal temporary level” in the RAM 203.

If it is determined in step S1302 that the resolution of the job attributes is “150 dpi” (“150 dpi” in step S1302), then in step S1304, the CPU 202 of the image processing apparatus 101 sets a value obtained by subtracting 1 from the “blank sheet removal temporary level” as the “blank sheet removal temporary level” in the RAM 203.

In step S1305, the CPU 202 of the image processing apparatus 101 confirms which of the values “character”, “photograph”, and “character/photograph” is set as the document type of the job attributes saved in the RAM 203.

If it is determined in step S1305 that the document type of the job attributes is “character” (“character” in step S1305), then in step S1306, the CPU 202 of the image processing apparatus 101 sets a value obtained by subtracting 1 from the “blank sheet removal temporary level” as the “blank sheet removal temporary level” in the RAM 203.

If it is determined in step S1305 that the document type of the job attributes is “photograph” (“photograph” in step S1305), then in step S1307, the CPU 202 of the image processing apparatus 101 sets a value obtained by adding 1 to the “blank sheet removal temporary level” as the “blank sheet removal temporary level” in the RAM 203.

In step S1308, the CPU 202 of the image processing apparatus 101 sets the value of the “blank sheet removal temporary level” as the blank sheet removal level of the job attributes.

The above processing is executed, allowing an image processing apparatus to identify the setting values of the detailed settings of a blank sheet determination that cannot be set by an app common to a plurality of vendors.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-085182, filed May 24, 2023, which is hereby incorporated by reference herein in its entirety.

What is claimed is:

1. An image processing apparatus comprising:
a reception unit configured to receive scan settings made by an application installed on an information processing apparatus and compatible with image processing apparatuses of a plurality of vendors in common from the information processing apparatus;
a scan unit configured to scan an image of a document based on the received scan settings and to generate image data;
an execution unit configured to execute a removal process on the generated image data based on a setting of removal included in the received scan settings; and
a transmission unit configured to transmit image data that is not removed by the removal process in the generated image data to the information processing apparatus,
wherein the execution unit executes the removal process based on the setting of the removal included in the received scan settings and a level of the removal set regardless of execution of the application.

2. The image processing apparatus according to claim 1, further comprising a receiving unit configured to receive a setting of the level of the removal from a user,
wherein the execution unit executes the removal process based on the setting of the removal included in the received scan settings and the set level of the removal.

3. The image processing apparatus according to claim 1, further comprising an identifying unit configured to identify the level of the removal based on a setting of a resolution included in the received scan settings,
wherein the execution unit executes the removal process based on the identified level of the removal.

4. The image processing apparatus according to claim 1, further comprising an identifying unit configured to identify the level of the removal based on a setting of a document type included in the received scan settings,
wherein the execution unit executes the removal process based on the identified level of the removal.

5. The image processing apparatus according to claim 1, wherein the scan settings are received from the information processing apparatus by the reception unit using an eSCL protocol.

6. The image processing apparatus according to claim 1, further comprising an analysis unit configured to analyze a scan ticket including the received scan settings,
wherein a scan job is generated by the analysis unit analyzing the scan ticket, and the generated scan job is executed, whereby the scan unit scans an image of the document and generates image data.

7. The image processing apparatus according to claim 1, wherein the scan settings include a setting of a resolution, a setting of a document type, and a two-sided setting.

8. The image processing apparatus according to claim 1, further comprising a determination unit configured to determine whether a setting value of the level of the removal is included in the received scan settings,
wherein in response to a case where the determination unit determines that the setting value of the level of the removal is not included in the received scan settings, the execution unit executes the removal process based on the setting of the removal included in the received scan settings and the level of the removal set regardless of the execution of the application.

9. The image processing apparatus according to claim 1, wherein the level of the removal is a setting value set as a default setting of the image processing apparatus.

10. An image processing method comprising:
receiving scan settings made by an application installed on an information processing apparatus and compatible with image processing apparatuses of a plurality of vendors in common from the information processing apparatus;
scanning an image of a document based on the received scan settings and generating image data;
executing a removal process on the generated image data based on a setting of removal included in the received scan settings; and
transmitting image data that is not removed by the removal process in the generated image data to the information processing apparatus,
wherein the removal process is executed based on the setting of the removal included in the received scan settings and a level of the removal set regardless of execution of the application.

11. The image processing method according to claim 10, further comprising receiving, as receipt, a setting of the level of the removal from a user,
wherein the removal process is executed based on the setting of the removal included in the received scan settings and the level of the removal set through the receipt.

12. The image processing method according to claim 10, further comprising identifying, as identification, the level of the removal based on a setting of a resolution included in the received scan settings,
wherein the removal process is executed based on the level of the removal set through the identification.

13. The image processing method according to claim 10, further comprising identifying, as identification, the level of the removal based on a setting of a document type included in the received scan settings,
wherein the removal process is executed based on the level of the removal set through the identification.

14. The image processing method according to claim 10, wherein the scan settings are received from the information processing apparatus using an eSCL protocol.

15. The image processing method according to claim 10, further comprising analyzing a scan ticket including the received scan settings,
wherein a scan job is generated by analyzing the scan ticket, and the generated scan job is executed, whereby an image of the document is scanned and image data is generated.

16. The image processing method according to claim 10, wherein the scan settings include a setting of a resolution, a setting of a document type, and a two-sided setting.

17. The image processing method according to claim 10, further comprising determining whether a setting value of the level of the removal is included in the received scan settings,
wherein it is determined that the setting value of the level of the removal is not included in the received scan settings, whereby the removal process is executed based on the setting of the removal included in the received scan settings and the level of the removal set regardless of the execution of the application.

18. The image processing method according to claim 10, wherein the level of the removal is a setting value set as a default setting.

19. A non-transitory computer-readable storage medium storing a program for executing an image processing method, the method comprising:
receiving scan settings made by an application installed on an information processing apparatus and compatible with image processing apparatuses of a plurality of vendors in common from the information processing apparatus;
scanning an image of a document based on the received scan settings and generating image data;
executing a removal process on the generated image data based on a setting of removal included in the received scan settings; and
transmitting image data that is not removed by the removal process in the generated image data to the information processing apparatus,
wherein the removal process is executed based on the setting of the removal included in the received scan settings and a level of the removal set regardless of execution of the application.

20. The non-transitory computer-readable storage medium according to claim 19, further comprising receiving, as receipt, a setting of the level of the removal from a user,
wherein the removal process is executed based on the setting of the removal included in the received scan settings and the level of the removal set through the receipt.
